(19) United States
(12) Patent Application Publication
(10) Pub. No.: US 2012/0191028 A1
(43) Pub. Date: Jul. 26, 2012

(54) VETERINARY DRESSING SOCK

(76) Inventor: Therese Leigh Entler, Vancouver, WA (US)

(21) Appl. No.: 13/436,869

(22) Filed: Mar. 31, 2012

Related U.S. Application Data
(63) Continuation-in-part of application No. 12/705,581, filed on Feb. 13, 2010.

(51) Int. Cl. A61D 9/00

(52) U.S. Cl. 602/63

(57) ABSTRACT

A veterinary dressing sock for positioning and holding a medical dressing on a wound site located on the foot of a pet providing both protection for the foot as well as breathability and moisture control at the wound site.

This is a Continuation-In-Part of co-pending U.S. application Ser. No. 12/705,581 filed Feb. 13, 2010.

### BACKGROUND OF THE INVENTION

1. Field of the Invention

The present invention generally relates to a veterinary dressing sock mountable on a pet's foot to protect the pet's foot as well as provide a platform for a medical dressing useful in treatment and/or healing of an injury to said foot. More particularly the present invention relates to a pet veterinary dressing sock that has a water proof flexible sole and a breathable upper portion to allow air in and moisture out thereby helping in the healing or treatment of a foot injury. Still more particularly the present invention relates to a pet veterinary dressing sock into which a dressing or medical sponge may be removably attached to said veterinary dressing sock to help promote the healing of an injury to the sole of the foot of a pet, particularly to the pads of canine and feline pets.

2. Description of the Related Art

The use of foot coverings for pets, most particularly dogs and cats, for protection from weather and/or chemicals is known. Some of these known foot covers have hard soles and some have flexible and/or soft soles. Some are waterproof or water resistant, and some are neither. However, none of them address the ability to removably mount a medical dressing. In fact many of them are more for the owner's pleasure than for the pet's wellbeing.

Typical of these known pet foot covers are for example, U.S. Pat. No. 4,458,431 issued Jul. 10, 1984 to Sinclair discloses such a protective boot having a sole member and a flexible upper member as well as a strapping system to secure said boot to a pet's foot.

U.S. Pat. No. 5,148,657 issued Sep. 22, 1992 to Stafford et al discloses another type of such dog boot having a sole portion, a tubular calf portion, and an ankle portion interconnecting the sole and calf portions.

And U.S. Patent Application Publication Number 2011/0041779 A1 published Feb. 24, 2001 to Hurwitz discloses a two boot system comprising as a critical element an inner gel boot or insole worn inside a second outer boot. Each of the two critical boot elements requires its own securing means. This reference lacks the teaching of a medical sponge having an adhesive to attach it to the boot as opposed it the traditional adhesion to the surface area around the actual wound. The inner boot comprises a gel bootie or gel insole to provide cushioning and/or cold/hot treatment to the affected foot area. It does not each how to mount a wound dressing on an open wound. Additionally, the use of a gel inner boot or inner sole discourages body moisture removal and air flow to the wound site.

Another direction pet foot coverings have taken is an over sleeve, usually having some elasticity that can be rolled onto or over to cover a traditional medical cast or previously mounted medical dressing. For example, U.S. Patent Application Publication Number 2004/0133144 published Jul. 8, 2004 of Crichton teaches an elongated tube having one open end and one closed end which can be stretched and rolled over a cast or bandage to completely cover said cast or bandage and render it water and dirt proof. However, this requires a separate cast or bandage be applied to the injured foot first. Additionally, the teaching is one of a total waterproof nature which will not allow air to circulate to and moisture circulates from the pet's foot.

U.S. Pat. No. 5,910,125 issued Jan. 8, 1999 to Cummings et al teaches a two part composite would dressing having separable components. The teaching requires the wound dressing to have one part of the composite dressing fixedly attached around the wound area and the second part of the composite dressing to be removably attached to the first part. This reference does not teach how to provide a wound dressing that is not attached to the wound area but instead attached to the wound sock or wrap thereby eliminating the need to fixedly attach anything to the wound area.

U.S. Pat. No. 5,708,985 issued Jan. 20, 1998 to Ogden teaches a method of knitting a sock for the human foot that provides additional friction inducing courses such that the planar surface of the sole is induced to not slide within the sock. The sock construction material includes acrylic, spandex, stretch polyester, and cotton interchangeably. However this reference doesn't teach or fairly suggest how to use any of these materials to make a garment of any kind that uses the surface of the fabric as a part of a sealing system. Further there is no teaching or suggestion of how to attach a wound dressing to the interior surface of said sock. Finally, friction increasing areas to contact the planar surface of the human foot would not be a consideration for a canine sock since canines walk on their toes and don't have a planar sole surface on the bottom of their feet.

Thus there remains a need for a pet veterinary dressing sock into which a medical dressing can be optionally removably mounted to protect a wounded foot and/or maintain medication upon the wound site, particularly a foot pat wound site; which promotes moisture removal and air exchange; and one resistant to removal by the pet.

### DISCLOSURE OF THE INVENTION

The present invention provides advantages and alternatives over the prior art by providing a pet veterinary dressing sock that protect the pet's foot from wet and dirty terrain while promoting healing of the wound site by encouraging body moisture removal and air flow to the wound site.

According to a further aspect of the present invention, there is provided a pet veterinary dressing sock that can be easily, securely, and comfortably mounted on a pet's while being resistant to the pet removing said pet veterinary dressing sock, and further providing a tactile sole portion to provide stable movement over various terrains.

According to yet another aspect of the present invention there is provided a veterinary dressing sock for positioning and holding a medical dressing on an animal foot wound site comprising in cooperative combination: a substantially tubular body having a first open end and a second closed end, the body further comprising an upper portion having a fitting panel for said veterinary dressing sock to the foot and a sole portion; said tubular body upper portion comprising an air and moisture breathable flexible tri-laminate material; said sole portion exterior surface comprising a waterproof tactile flexible material and interior surface comprising suitable area for mounting a medical dressing thereto; a securing strap securable around the periphery of said first open end of said substantially tubular body; a removably mounted medical dressing; and a means of securing and releasing said securing strap and said fitting panel thereby creating a desired veterinary dressing sock holding a medical dressing in a desired position.

According to a yet further aspect of the present invention there is provided a veterinary dressing sock for positioning and holding a medical dressing on an animal foot wound site comprising in cooperative combination: a substantially tubular body having a first open end and a second closed end, the body further comprising an upper portion having a fitting panel for said veterinary dressing sock to the foot and a sole portion; said tubular body upper portion comprising an air and moisture breathable flexible tri-laminate material further characterized as having at least one dart to remove excess material and shape said tubular body about said first open end and at least one dart to remove excess material and shape said tubular body about said second closed end; said sole portion exterior surface comprising a waterproof tactile flexible material and interior surface comprising suitable area for mounting a medical dressing thereto; a securing strap securable around the periphery of said first open end of said substantially tubular body; a removably mounted medical dressing; and a means of securing and releasing said securing strap and said fitting panel thereby creating a desired veterinary dressing sock holding a medical dressing in a desired position.

According to still another aspect of the present invention there is provided a veterinary dressing sock for positioning and holding a medical dressing on an animal foot wound site providing improved fit and improved wearing comfort through the inclusion of shaping darts on the first open end area of the upper body portion of said veterinary dressing sock.

According to still yet another aspect of the present invention there is provided a veterinary dressing sock for positioning and holding a medical dressing on an animal foot wound site providing improved wearing comfort comprising an upper body portion of a breathable synthetic fabric/breathable neoprene material and a waterproof tactile foot pad/sole portion fabric.

The present invention thus advantageously provides a pet veterinary dressing sock that has a waterproof sole portion, a breathable body portion, and the ability to removably mount a dressing or medical sponge to the interior of said veterinary dressing sock to protect a wound site and/or retain medication on a wound site. Further, the present invention advantageously provides the above benefits with a veterinary dressing sock that is resistant to the pet removing it.

### BRIEF DESCRIPTION OF THE DRAWINGS

FIG. 1 shows a perspective top or front view of one preferred embodiment of the present invention in an open position ready to mount on a pet's foot.

FIG. 2 shows a plan front view of one preferred embodiment of the present invention in an open position showing a cut-away section showing the medical dressing mounting area.

FIGS. 3a & 3b show plan front and back views respectively, of a medical dressing suitable for removably mounting within a preferred embodiment of the present invention.

FIGS. 4a & 4b show perspective front/top and back/bottom views of a closed preferred embodiment of the present invention.

FIG. 5 shows four of a preferred embodiment of the present invention mounted on a canine.

FIG. 6 shows a perspective front view of particularly preferred embodiment of the present invention.

FIG. 7 shows a plan back view of a particularly preferred embodiment of the present invention.

FIG. 8 shows a plan front view of another particularly preferred embodiment of the present invention.

FIG. 9 shows a plan front view of yet another particularly preferred embodiment of the present invention.

FIG. 10 shows a plan back view of the particularly preferred embodiment of the present invention of FIG. 9.

FIG. 11 shows a front plan view of the particularly preferred embodiment of the present invention of FIG. 9partially sealed one of two sealing means.

FIG. 12 shows a front plan view of the particularly preferred embodiment of the present invention of FIG. 9 having both first and second sealing means in a sealed position.

### DESCRIPTION OF THE PREFERRED EMBODIMENTS OF THE INVENTION

Reference will now be made to the drawings, wherein to the extent possible like reference numerals are utilized to designate like components throughout the various views. Referring to FIG. 1, which presents a perspective front view of one preferred embodiment of a veterinary dressing sock 100 of the present invention showing a veterinary dressing sock upper portion 1 having at least one securing means 5 thereon, a part of a veterinary dressing sock sole portion 2, a veterinary dressing sock upper portion fitting panel 3 having at least one securing means 5 thereon positioned to cooperatively mate with complimentary securing means 5 of said veterinary dressing sock upper portion 1, a securing strap 4 also having a securing means 5 thereon. Also shown is an edge sealing means 6 covering the exposed edges of said veterinary dressing sock upper portion 1. The preferred securing means is a hook and loop tape means well known in the art.

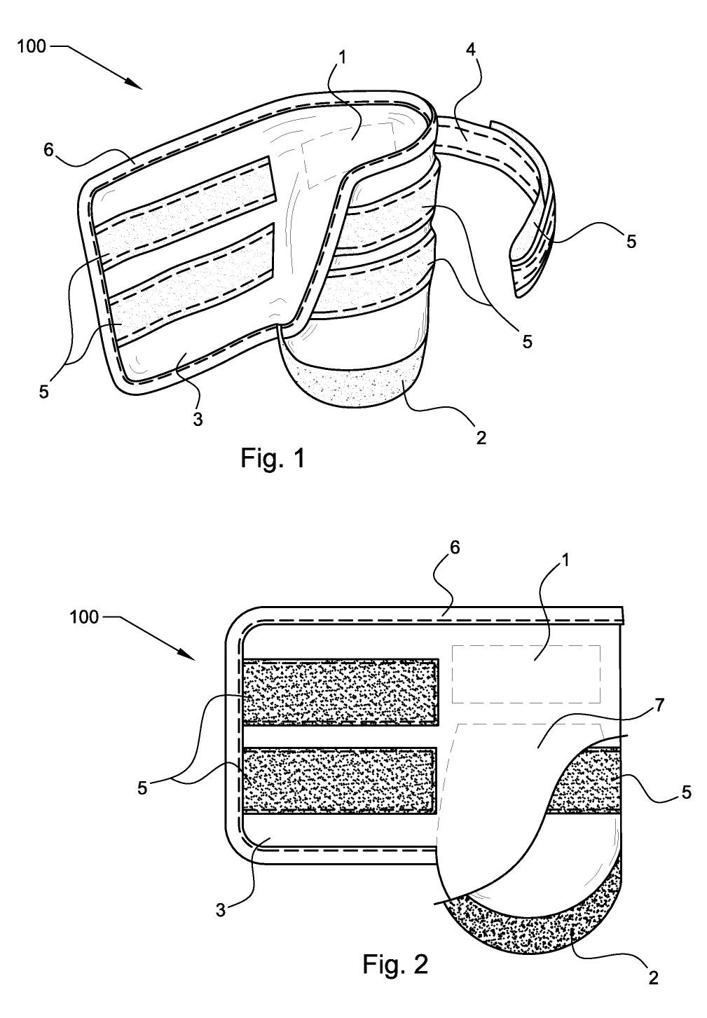

Referring now to FIG. 2 there is shown a plan front or top view of the preferred embodiment of FIG. 1 having a veterinary dressing sock upper portion 1 having at least one securing means 5 thereon, a sole portion 2 comprising a waterproof durable flexible material. As further shown in FIG. 2, there is an edge sealing means 6 covering the exposed edges of said veterinary dressing sock upper portion 1. The presently preferred sole portion 2 material has a tactile outer surface that provides a sense of sure-footedness allowing the pet to walk comfortably and stably on a multitude of surfaces. As also shown in FIG. 2 exposed to view by the partial cut away, is the medical dressing mounting area 7 located on the interior of said veterinary dressing sock sole portion 2. Preferably this medical dressing mounting area 7 comprises a material having a surface which is suitable for attachment of the medical dressing by means of a temporary adhesive on the surface of the medical dressing. The presently preferred material is Lycra fabric with a smooth surface. It is also preferred though not critical that this Lycra fabric surface comprises the inside surface of the sole portion 2 fabric, although a separate material may be utilized if desired.

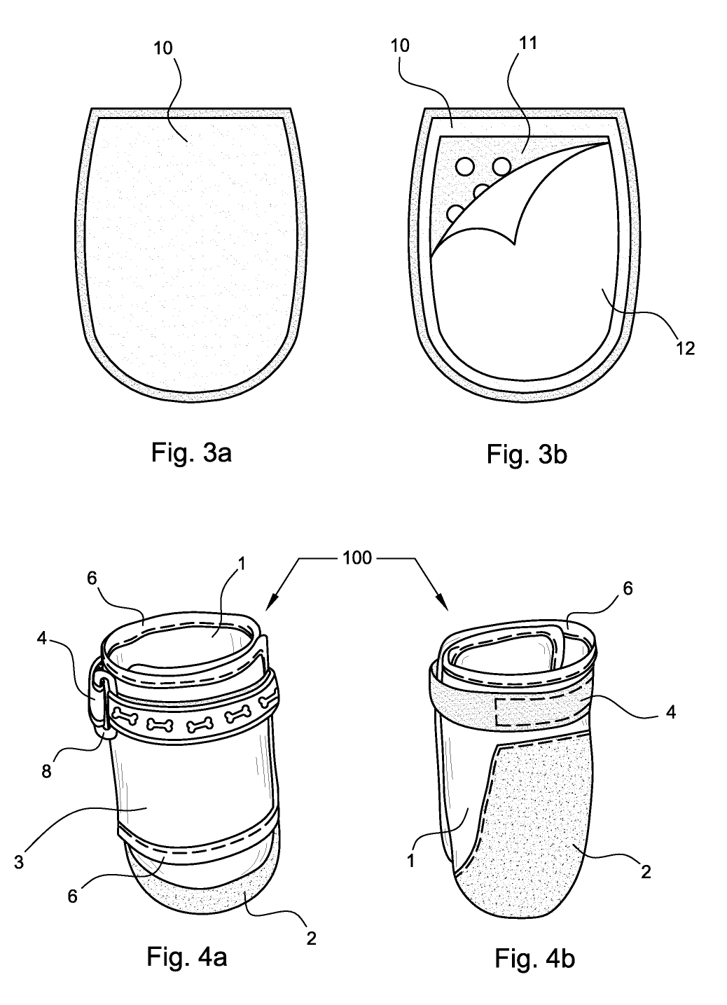

FIG. 3a shows a front plan view medical dressing 10 suitable for use in the present invention. A presently preferred medical dressing 10 is a surgical sponge having a porous plastic covering. The presently preferred medical dressing 10 comprises a multiple layer material having sterile gauze covered on a first surface/side by a polyethylene (PE) film wherein the film is perforated to allow passage of air and moisture into the sterile gauze material and a polyester film double coated with a removable acrylic adhesive on the second surface/side of said medical dressing 10. The adhesive on the first surface/side attaching the polyester film to the sterile gauze material and the second surface/side covered by a removable adhesive protecting layer which is removed before the medical dressing 10 is attached to the medical dressing mounting area 7 on the interior of the veterinary dressing sock sole portion 2. Preferably the adhesives used are latex free, and can be of any suitable formulation. The presently preferred gauze comprises 30% polyester and 70% viscose fabric.

FIG. 3b shows a back plan view of a medical dressing 10 having an adhesive 11 capable of removably securing said medical dressing 10 to the interior of veterinary dressing sock sole portion 2 and an adhesive protective covering 12 intended to be removed to expose said adhesive 11 allowing removable securing of said medical dressing 10 to the interior of veterinary dressing sock sole portion 2.

Turning to FIG. 4a, there is shown a perspective top/front view of one preferred embodiment of a veterinary dressing sock 100 of the present invention in a closed orientation as it would be once mounted on a pet's foot. Shown is veterinary dressing sock upper portion 1 having edge sealing means 6, securing strap 4, securing strap D-ring 8, veterinary dressing sock upper portion closure panel 3 in the closed position and a part of veterinary dressing sock sole portion 2.

FIG. 4b shows a perspective bottom/back view of the preferred embodiment of a veterinary dressing sock veterinary dressing sock 100 of the present invention of FIG. 4a in a closed orientation as it would be once mounted on a pet's foot. Shown is veterinary dressing sock upper portion 1 having edge sealing means 6, and securing strap 4 and veterinary dressing sock sole portion 2.

Further turning to FIG. 5 there are shown a pet dog 200 with a veterinary dressing sock 100 mount on each of the dog's four feet.

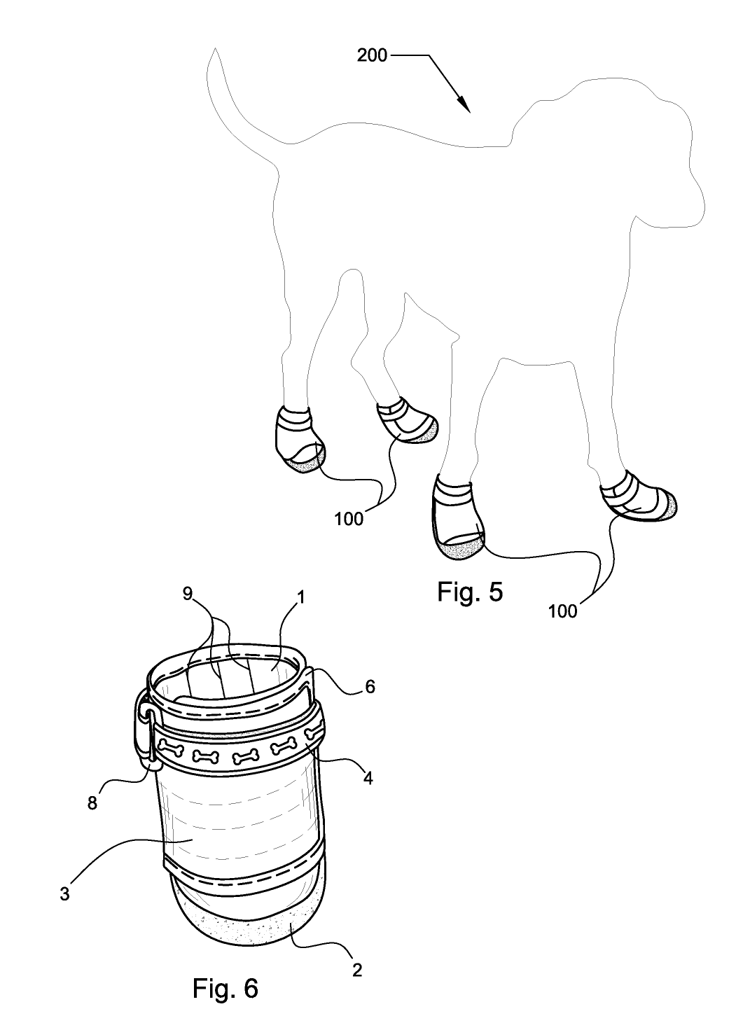

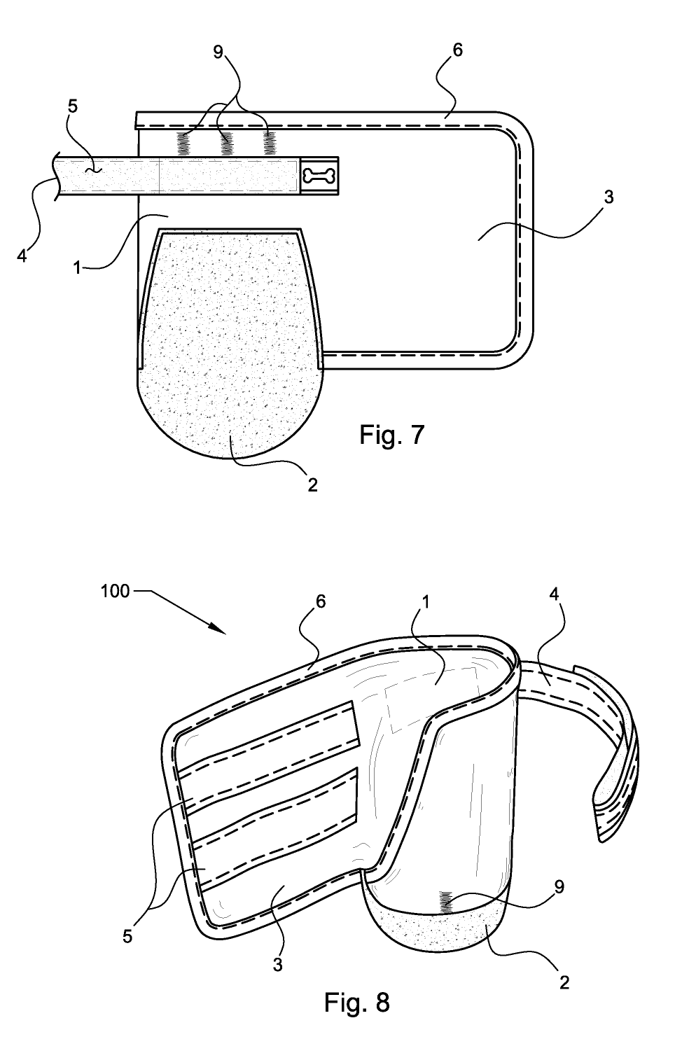

FIG. 6 shows a perspective top/front view of one preferred embodiment of a veterinary dressing sock 100 of the present invention in a closed orientation as it would be once mounted on a pet's foot. Shown is veterinary dressing sock upper portion 1 having edge sealing means 6, securing strap 4, securing strap D-ring 8, and additionally upper body portion shaping darts 9 utilized to shape and removes excess material providing an improved fit and improved security; veterinary dressing sock upper portion closure panel 3 in the closed position and a part of veterinary dressing sock sole portion 2.

FIG. 7 shows a plan bottom/back view of one preferred embodiment of a veterinary dressing sock 100 of the present invention in an open orientation as it would be prior to mounting on a pet's foot. Shown is veterinary dressing sock upper portion 1 having edge sealing means 6, and securing strap 4 with securing means 5, dressing cover upper portion closure panel 3 and upper body portion shaping darts 9. It is to be appreciated to those skilled in the art that the number, position, and size of the upper body portion shaping darts 9 may be adjusted to provide a desired level of excess material removal and/or security when mounted on a pet's foot.

FIG. 8 shows a plan front/top view of another preferred embodiment of a veterinary dressing sock 100 of the present invention in and open orientation as it would be prior to mounting on a pet's foot. Shown here is a veterinary dressing sock upper portion 1 having an exterior fabric surface 10 comprising an unbroken loop (UBL) fabric thereby eliminating the need for the loop portion of the securing means 5. Also shown, is a preferred embodiment having a toe shaping dart or pleat 9.

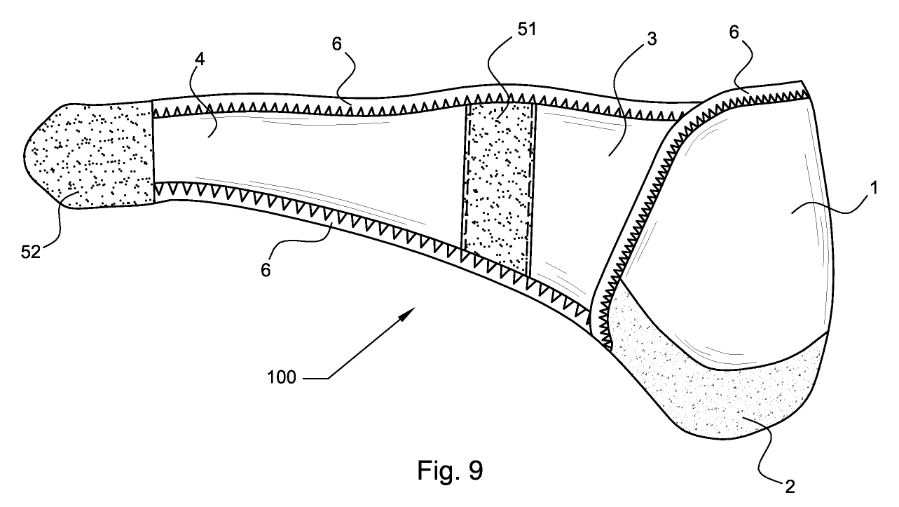

FIG. 9 shows a plan front/top view of the presently preferred embodiment of a veterinary dressing sock 100 of the present invention in an open orientation as it would be prior to mounting on a pet's foot. Shown is a veterinary dressing sock upper portion 1 having edge sealing means 6, and securing strap section 4, being a continuation of sock upper portion 1, with multiple securing means 51 and 52, dressing cover upper portion closure panel 3 and a portion of veterinary dressing sock sole portion 2. It is to be appreciated to those skilled in the art that the number, position, and size of the multiple securing means 5 are determined and positioned to provide a desired level of security when mounted on a pet's foot.

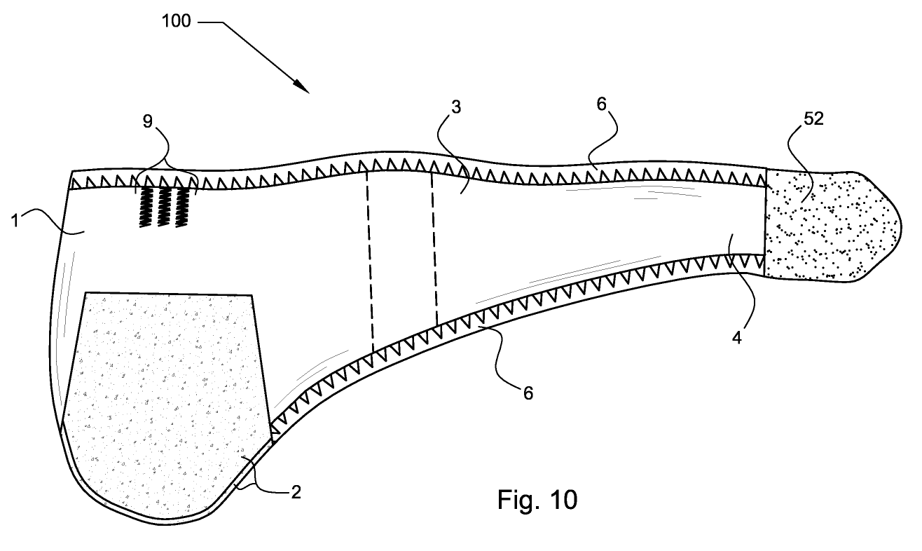

Next, FIG. 10 shows a plan back/bottom view of the presently preferred embodiment of a veterinary dressing sock 100 of the present invention in an open orientation as it would be prior to mounting on a pet's foot. Shown is a veterinary dressing sock upper portion 1 having edge sealing means 6, and securing strap section 4, being a continuation of sock upper portion 1, with securing means 52, dressing cover upper portion closure panel 3, a veterinary dressing sock sole portion 2, upper body portion shaping darts 9 utilized to shape and removes excess material providing an improved fit and improved security. It is to be appreciated to those skilled in the art that the number, position, and size of the upper body portion shaping darts 9 may be adjusted to provide a desired level of excess material removal and/or security when mounted on a pet's foot.

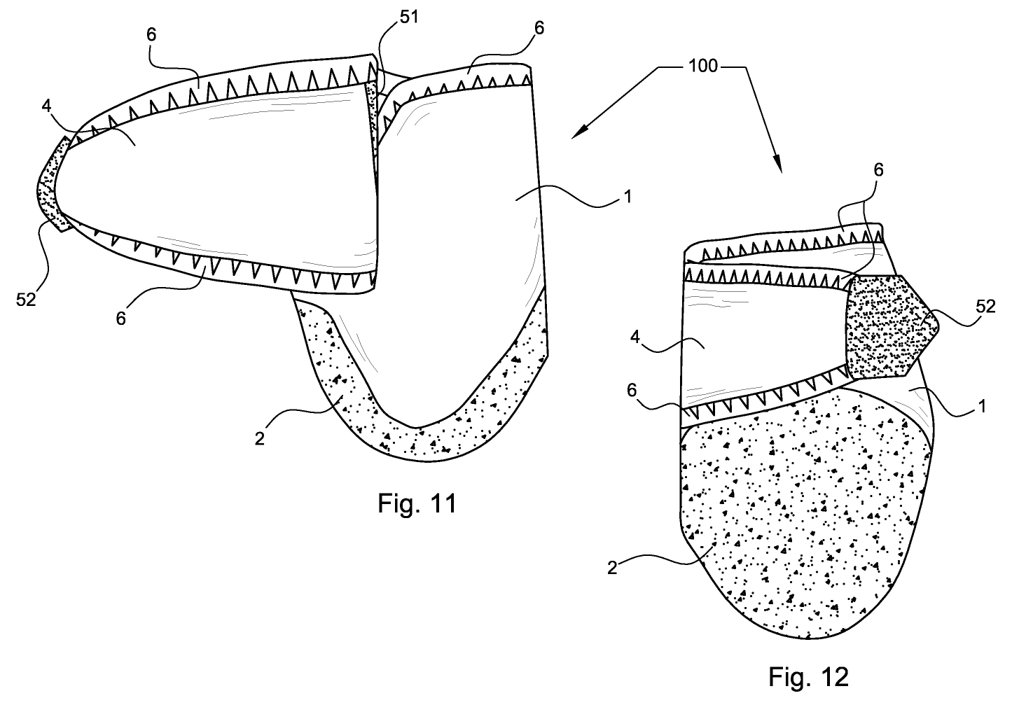

FIG. 11 shows a plan front/top view of the presently preferred embodiment of a veterinary dressing sock 100 of the present invention in as it would be during mounting onto a pet's foot. Shown is a veterinary dressing sock upper portion 1 having edge sealing means 6, and securing strap section 4, being a continuation of sock upper portion 1, with multiple securing means 51 and 52, dressing cover upper portion closure panel 3 and a portion of veterinary dressing sock sole portion 2. It is to be appreciated to those skilled in the art that the number, position, and size of the multiple securing means 51 and 52 are determined and positioned to provide a desired level of security when mounted on a pet's foot. Here the mounting means 51 has been attached in position to secure the sock such that the wound dressing (not shown) is properly positioned over the wound area.

Finally, FIG. 12 shows a plan front/top view of the presently preferred embodiment of a veterinary dressing sock 100 of the present invention in as it would be during mounting onto a pet's foot. Shown is a veterinary dressing sock upper portion 1 having edge sealing means 6, and securing strap section 4, being a continuation of sock upper portion 1, with multiple securing means 51 (see FIG. 11) and 52, dressing cover upper portion closure panel 3 and a portion of veterinary dressing sock sole portion 2. It is to be appreciated to those skilled in the art that the number, position, and size of the multiple securing means 51 and 52 are determined and positioned to provide a desired level of security when mounted on a pet's foot. Here the mounting means 52 has been attached in position to finalize the securing the sock such that the wound dressing (not shown) is properly positioned over the wound area and the sock is securely mounted on the pet's foot. It is to be appreciated that the use of at least two securing means 51 and 52 allows the boot to be positioned and secured with the least amount of restriction to blood circulation within the foot and leg of the pet. It is be further appreciated that the width of the securing strap section 4 helps encourage circulation to the wound area and reduces the potential for onset of a tourniquet effect.

The presently preferred veterinary dressing sock upper portion 1 material is one that promotes the transfer of air and moisture to and from the wound site to help promote healing. Particularly preferred is the Breath-O-prene brand tri-laminate material, as disclosed in U.S. Pat. No. 6,861,379 issued Mar. 1, 2005 to Blaszczykiewicz and assigned to AccuMED Technologies of Buffalo, N.Y. and incorporated herein by reference. Most preferred are Breath-O-prene materials having a nylon spandex blend fabric on one surface and an unbroken loop (UBL) fabric on the other side with an open cell polyurethane center layer. The presently preferred securing means 5 is hook and loop tape particularly Velcro brand from Velcro USA of Manchester, N.H. Especially preferred is the use of Velcro hook material and unbroken loop (UBL fabric surface of the sock upper body portion to form the securing means of the present invention.

The preferred sole material 2 is flexible, waterproof, physically tough and sturdy. The presently preferred veterinary dressing sock sole portion comprises Toughtek; a PVC copolymer coated polyester fabric as the outer surface from Harrison Technologies, of Broadalbin, N.Y.

The presently preferred gauze is gauze made of 30% polyester and 70% viscose manufactured by Kingphar Medical Material Co., Ltd of Hubei, China. The presently preferred adhesive films are double coated pressure sensitive adhesive films comprise a thin polyester film double coated with removable acrylic adhesive on one side and a high performance permanent rubber adhesive on the other side, manufactured by Scapa North America in Windsor, Conn. This provides a permanent adhesive bond between the gauze and the thin polyester film and a removably adhesive bond of the thin polyester film to the interior surface of the veterinary dressing sock upper portion 1 material. This use of adhesive to attach a gauze sponge/dressing to a support instead of directly to the wound surface is one of the advantages of the present invention.

The presently preferred securing strap 4 comprises a portion of the veterinary dressing sock upper portion 1 material. Another suitable preferred securing strap 4 material comprises nylon webbing. The preferred D-ring 8 is a plastic ring of any desired shape including a D-ring, O-ring, and the like.

The various components of the present invention are preferably sewn together using nylon or Dacron thread using well known techniques in the sewing arts. However, it is to be appreciated that the manner of attachment of the various components to one another may be by any suitable well known method, such as, for example, adhesives, heat welding, and the like. It is further to be appreciated that while the present invention provides flexibility in fitting to various sized animal feet this can be further enhanced as to fit and comfort by providing a variety of physical sizes.

In practice the veterinary dressing sock of the present invention initially has the securing strap and the mounting panel in the open position. The medical dressing is positioned on the interior surface of the veterinary dressing sock. The veterinary dressing sock is then positioned on the animals wounded foot such that the medical dressing covers the wound site. The veterinary dressing sock is then secured on the animal's foot by securing the mounting panel and the securing strap in their closed positions. The veterinary dressing sock is positioned such that the sole portion is over the bottom of the animal's foot.

Although the preferred embodiments of the present invention has been disclosed, various changes and modifications may be made without departing from the scope of the invention as set forth in the appended claims.

What is claimed is:

1. A veterinary dressing sock for positioning and holding a medical dressing on an animal foot wound site comprising in cooperative combination:
a substantially tubular body having a first open end and a second closed end, the body further comprising an upper portion having a fitting panel for said veterinary dressing sock to the foot and a sole portion;
said tubular body upper portion comprising an air and moisture breathable flexible tri-laminate material;
said sole portion exterior surface comprising a waterproof tactile flexible material and interior surface comprising a medical dressing mounting area;
a securing integral strap portion of said veterinary dressing sock securable around the periphery of said first open end of said substantially tubular body;
a removably mounted medical dressing mounted to said interior surface of said veterinary dressing sock; and
a means of securing and releasing said securing strap and said fitting panel thereby creating a desired veterinary dressing sock holding a medical dressing in a desired position.

2. The veterinary dressing sock for positioning and holding a medical dressing on an animal foot wound site as claimed in claim 1 wherein, said tubular body upper portion comprises a breathable tri-laminate having a open-cell foam having a first face and a second face covered on said open-cell foam first face and the second face by four-way stretchable fabric designed to wick moisture and allow air exchange.

3. The breathable tri-laminate as claimed in claim 2 wherein, said four-way stretchable fabric on both first and second faces is a nylon and spandex blend fabric.

4. The breathable tri-laminate as claimed in claim 2 wherein, said four-way stretchable fabric is a nylon and spandex blend fabric on the first face of said open-cell foam and an unbroken loop (UBL) fabric on the second face of said open-cell foam.

5. The securing and releasing means as claimed in claim 1 wherein, said means are co-operatively positioned hook containing and loop containing tape.

6. The securing and releasing means as claimed in claim 1 wherein, said securing and releasing means comprise hook containing tape and an unbroken loop (UBL) fabric on the second face of said upper portion.

7. The medical dressing mounting area as claimed in claim 1 wherein, said mounting area comprises a smooth surfaced spandex covered nylon fabric.

8. The removably mounted medical dressing as claimed in claim 1 wherein, said dressing comprises a medical sponge having an adhesive film having a first surface permanently fixed to one surface of said medical sponge and said adhesive film having a second surface having removable adhesive allowing removably fixing said medical sponge to said veterinary dressing sock.

9. A veterinary dressing sock for positioning and holding a medical dressing on an animal foot wound site comprising in cooperative combination:
a substantially tubular body having a first open end and a second closed end, the body further comprising an upper portion having a fitting panel for said veterinary dressing sock to the foot and a sole portion;
said tubular body upper portion comprising an air and moisture breathable flexible tri-laminate material further characterized as having at least one dart to remove excess material and shape said tubular body about said first open end and at least one dart to remove excess material and shape said tubular body about said second closed end;
said sole portion exterior surface comprising a waterproof tactile flexible material and interior surface comprising a medical dressing mounting area;
a securing strap securable around the periphery of said first open end of said substantially tubular body;
a removably mounted medical dressing; and
a means of securing and releasing said securing strap and said fitting panel thereby creating a desired veterinary dressing sock holding a medical dressing in a desired position.

10. The veterinary dressing sock for positioning and holding a medical dressing on an animal foot wound site as claimed in claim 9 wherein, said tubular body upper portion comprises a breathable tri-laminate having a open-cell foam having a first face and a second face covered on said open-cell foam first face and the second face by four-way stretchable fabric designed to wick moisture and allow air exchange.

11. The breathable tri-laminate as claimed in claim 10 wherein, said four-way stretchable fabric on both first and second faces is a nylon and spandex blend fabric.

12. The breathable tri-laminate as claimed in claim 10 wherein, said four-way stretchable fabric is a nylon and spandex blend fabric on the first face of said open-cell foam and an unbroken loop (UBL) fabric on the second face of said open-cell foam.

13. The veterinary dressing sock for positioning and holding a medical dressing on an animal foot wound site as claimed in claim 9 wherein, said tubular body upper portion comprises a plurality of darts about said first open end.

14. The veterinary dressing sock for positioning and holding a medical dressing on an animal foot wound site as claimed in claim 13 wherein, said tubular body upper portion comprises three darts about said first open end.

15. The securing and releasing means as claimed in claim 9 wherein, said means are co-operatively positioned hook containing and loop containing tape.

16. The securing and releasing means as claimed in claim 9 wherein, said securing and releasing means comprise hook containing tape and an unbroken loop (UBL) fabric on the second face of said upper portion.

17. The medical dressing mounting area as claimed in claim 9 wherein, said mounting area comprises a smooth surfaced Lycra fabric.

18. The removably mounted medical dressing as claimed in claim 9 wherein, said dressing comprises a medical sponge having an adhesive film having a first surface permanently fixed to one surface of said medical sponge and said adhesive film having a second surface having removable adhesive allowing removably fixing said medical sponge to said veterinary dressing sock.

19. A veterinary dressing sock for positioning and holding a medical dressing on an animal foot wound site comprising in cooperative combination:
a substantially tubular body having a first open end and a second closed end, the body further comprising an upper portion having a fitting panel for said veterinary dressing sock to the foot and a sole portion;
said tubular body upper portion comprising an air and moisture breathable flexible tri-laminate material further characterized as having at least one dart to remove excess material and shape said tubular body about said first open end and at least one dart to remove excess material and shape said tubular body about said second closed end;
said sole portion exterior surface comprising a waterproof tactile flexible material and interior surface comprising a medical dressing mounting area;
a securing strap securable around the periphery of said first open end of said substantially tubular body comprising an extension of said tubular body upper portion and having a plurality of securing means for securing said securing strap to the outer surface of said tubular body upper portion;
a removably mounted medical dressing; and
a means of securing and releasing said securing strap and said fitting panel thereby creating a desired veterinary dressing sock holding a medical dressing in a desired position.

20. The veterinary dressing sock for positioning and holding a medical dressing on an animal foot wound site as claimed in claim 19 wherein, said securing strap has a width and geometry assisting in the prevention of circulation inhibition.
